(19) United States
(12) Patent Application Publication
(10) Pub. No.: US 2025/0132905 A1
(43) Pub. Date: Apr. 24, 2025

(54) SYSTEMS AND METHODS FOR RESTRICTING FIDO KEY DERIVATION IDENTITY BINDING

(71) Applicant: Capital One Services, LLC, McLean, VA (US)

(72) Inventors: Kevin OSBORN, Newton Highlands, MA (US); Srinivasa CHIGURUPATI, Long Grove, IL (US); Wayne LUTZ, Fort Washington, MD (US)

(73) Assignee: Capital One Services, LLC, McLean, VA (US)

(21) Appl. No.: 18/917,527

(22) Filed: Oct. 16, 2024

Related U.S. Application Data
(60) Provisional application No. 63/544,992, filed on Oct. 20, 2023.

(51) Int. Cl. H04L 9/08; H04L 9/30; H04L 9/32

(52) U.S. Cl. CPC H04L 9/0861; H04L 9/0894; H04L 9/30; H04L 9/3234

(57) ABSTRACT

Systems and methods are directed to generation of verifiable FIDO security keys based on hierarchically generated child keys from an extended security key pair, wherein the extended public key is stored on a verification server of the account issuing entity. In the described implementation, child FIDO key pair are hierarchically derived from an extended private/public key pair. A public key provided during a FIDO registration can be securely tied to a user identity based on verification of FIDO registration data by the issuing server using the corresponding extended public key. Accordingly, a FIDO public key is linked to a thoroughly vetted user identity, during the registration process, without an authentication action from the user. The disclosed systems and methods further enable a re-issued FIDO authenticator device to perform FIDO transactions with FIDO services previously registered against the replaced authenticator device.

### CROSS-REFERENCE TO RELATED APPLICATION

This application claims priority to U.S. Provisional Patent Application No. 63/544,992, filed Oct. 20, 2023, the contents of which are incorporated herein by reference in their entirety.

### FIELD OF THE DISCLOSURE

The present disclosure is generally related to authentication systems, and more specifically to implementations of an optimized identity binding in Fast Identity Online (FIDO) authentication processes.

### BACKGROUND

Public key challenge authentication protocols such as FIDO2 and/or passkeys are reliable in producing unforgeable authentications that may be facilitated using security keys stored on a user device. The security keys are randomly generated and used in a FIDO authentication process to sign a FIDO challenge when accessing an online resource using FIDO-based security. However, the association of such authentication credentials (e.g., the FIDO signature, provided by a user device) to a trusted user identity, is generally based on user-provided identification credentials (e.g., username, password, government-issued identification) provided during the FIDO registration process.

The fragile FIDO registration process, based on user-provided authentication data, for associating a registered FIDO key pair to a trusted user identity, represent a weak link in the process as such information may be fraudulently obtained and transmitted along with compromised FIDO credentials for creating an unauthorized FIDO account, thus impeding the security of the authentication process.

These and other deficiencies exist. As such, there is need for an improved system and process for a secure and accessible determination of trust in a source device and/or a user initiating a FIDO registration request.

### SUMMARY OF THE DISCLOSURE

One aspect of the present disclosure is directed to a method for generation of verifiable Fast Identity Online (FIDO) security keys, the method may comprise: generating an extended public key from an extended private key, the extended public key being stored with an account issuing entity; deriving, from the extended private key, a plurality of child key pairs, including a plurality of child private keys and a plurality of corresponding child public keys, wherein the extended private key is stored on an authenticator device associated with a user, the authenticator device being provided by the account issuing entity; initiating a FIDO registration of the authenticator device with a FIDO-reliant site using a user-specific identifier and a site-specific child public key derived for the FIDO-reliant party; sending, by the FIDO-reliant party, the user-specific identifier and the site-specific child public key to the issuing entity; verifying, by the account issuing party, that the site-specific child public key is associated with the user-specific identifier using the extended public key to derive a matching key, and completing the FIDO registration upon receiving a verification message from the account issuing entity.

One aspect of the present disclosure is directed to a system for implementing a streamlined FIDO registration and login process, the system comprising an authenticator device configured with a processor; and a memory, the memory containing a user-specific identifier, an extended private FIDO key generated using a hierarchically deterministic key generation algorithm, wherein the processor is configured to: generate a child FIDO key pair including a child private key and a child public key; transmit the child public key along with the user-specific identifier to a FIDO-reliant server during a FIDO registration process associated with the authenticator device. The system further includes a server, comprising a processor; and a memory, containing the user-specific identifier and an extended public FIDO key generated from the extended private FIDO key, the processor being configured to: receive the child public key along with the user-specific identifier from the FIDO reliant server during the FIDO registration process of the authenticator device, verify that the child public key is associated with the user-specific identifier using the extended public key, and transmit a verification message to the FIDO-reliant server, the verification being operative to complete a registration of the authenticator device associated with the child public key and the user-specific identifier.

Another aspect of the present disclosure is directed to a non-transitory computer-readable medium comprising instructions for execution by a computer hardware arrangement, wherein, upon execution of the instructions the computer hardware arrangement is configured to perform procedures comprising: generating an extended public key from an extended private key, the extended public key being stored with an account issuing entity; deriving, from the extended private key, a plurality of child key pairs, including a plurality of child private keys and a plurality of corresponding child public keys, wherein the extended private key is stored on an authenticator device associated with a user, the authenticator device being provided by the account issuing entity; initiating a FIDO registration of the authenticator device with a FIDO-reliant site using a user-specific identifier and a site-specific child public key derived for the FIDO-reliant party; sending, by the FIDO-reliant party, the user-specific identifier and the site-specific child public key to the issuing entity; verifying, by the account issuing party, that the site-specific child public key is associated with the user-specific identifier using the extended public key to derive a matching key, and completing the FIDO registration upon receiving a verification message from the account issuing entity.

### BRIEF DESCRIPTION OF THE DRAWINGS

FIG. 1A illustrates an exemplary process implementation for generation of an extended private and public key pairs, in accordance with embodiments of the present disclosure.

FIG. 1B illustrates an exemplary process implementation for hierarchically deterministic generation of child security key pairs, independently verifiable by an extended public key, in accordance with embodiments of the present disclosure.

FIG. 1C illustrates an exemplary process implementation for generating verifiable FIDO keys, in accordance with embodiments of the present disclosure.

FIG. 2 illustrates an exemplary system implementation for generating verifiable FIDO keys, in accordance with embodiments of the present disclosure.

FIG. 3 illustrates an exemplary operational flow diagram for the process implementation illustrated in FIG. 1C, in accordance with embodiments of the present disclosure.

FIG. 4 illustrates an exemplary operational flow diagram for a FIDO verification process to port FIDO access capability from a de-activated user authenticator device to a replacement user authenticator device, in accordance with embodiments of the present disclosure.

FIG. 5 illustrates an exemplary operational flow diagram directed to a process for independent verification of a FIDO signature by a FIDO-reliant service, in accordance with embodiments of the present disclosure.

FIG. 6 illustrates an exemplary block diagram of an exemplary system, in accordance with embodiments of the present disclosure.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The present disclosure is directed to systems and methods for personalizing FIDO key derivation process in order to streamline the fragile device and/or key registration phase which connects a user identity (e.g., based on user provided authentication data) to a corresponding FIDO key pair. The proposed solution is based on generating the site-specific FIDO security key pairs in a hierarchical deterministic (HD) fashion from an extended origin/master private key. In this way a corresponding extended origin/master public key (derived from the extended origin/master private key) can be stored with a user account and/or user device issuing entity (also referred to as the verification party and/or verification server for the purposes of the present disclosure). The extended origin/master public key may then be used by the verification party for verifying a site-specific FIDO public key, provided during a FIDO registration phase, and linking of the site-specific FIDO public key to a thoroughly vetted user identity. The proposed scheme would allow subsequently derived child key pairs corresponding to various site-specific FIDO key pairs (e.g., generated for registering with various distinct FIDO-reliant sites/services) to be validated back to a thoroughly vetted user identity (e.g., as maintained by the issuing entity) using the extended origin/master public key stored by the issuing entity.

According to the recited process, an extended origin/master private key may be generated (e.g., from a known seed value) and stored on the authenticator device (e.g., contactless card or a mobile authenticator device), while a corresponding extended origin public key (e.g., generated from the extended origin private key) is transmitted to and stored with the issuing party associated with the user authenticator device. Subsequently, during a FIDO registration process with a specific FIDO-reliant site, a unique child private/public key pair is generated by the authenticator device using the extended origin private key. The child private key is kept on the authenticator device for digitally signing a FIDO challenge from a FIDO-reliant service/site, while the child public key is registered, along with a user-specific identifier (e.g., email address, phone number), with the FIDO-reliant site and/or service and used for verifying the said digital signature.

As described above, the standard FIDO registration process requires a user identity authentication process to be carried out (based on additional identity verification data provided by the user) in order to securely bind a user's identity with a registered FIDO public key. However, the proposed implementation, described herein, obviates this step by leveraging the hierarchically deterministic (HD) aspect of the generated site-specific FIDO key pairs to port the pubic key verification process (e.g., association of a registered public key to a trusted user identity) to the issuing party. Accordingly, the FIDO-reliant service, upon receiving a FIDO registration request, communicates the registration data (comprising a user-specific identifier and a child public key) to the issuing entity associated with the user authenticator device. Responsive to this communication, the issuing entity may perform a verification of the child public key (in association with the user-specific identifier) based on the stored extended origin public key. For example, the extended origin public key may be used to re-derive a matching child public key based on a specific FIDO site identifier. If a derivation of a matching child public key is successful, the issuing entity confirms the validity of the registration data received from the FIDO-reliant service. A verification message sent by the issuing party, to the FIDO-reliant party, will provide the provenance determination and user identity binding required to successfully complete the FIDO registration process without necessitating further authentication actions from the user. Accordingly, the described scheme obviates a need for a direct authentication of the user identity (e.g., by the user via the a user communication device) during the device registration process with a FIDO-reliant service and/or site.

As described above, the proposed FIDO key derivation process, modified for provenance determination and identity binding, is based on a hierarchical derivation of child FIDO key pairs for each distinct FIDO-reliant service. The aforementioned child key pairs are derived from an extended origin private key associated with a corresponding extended origin pubic key. accordingly, a new child key pair registered with a FIDO-reliant site becomes a verifiable key (e.g. registered key may be accompanied with some metadata that identifies the key as a verifiable key.) that may be verified with the corresponding extended origin public key.

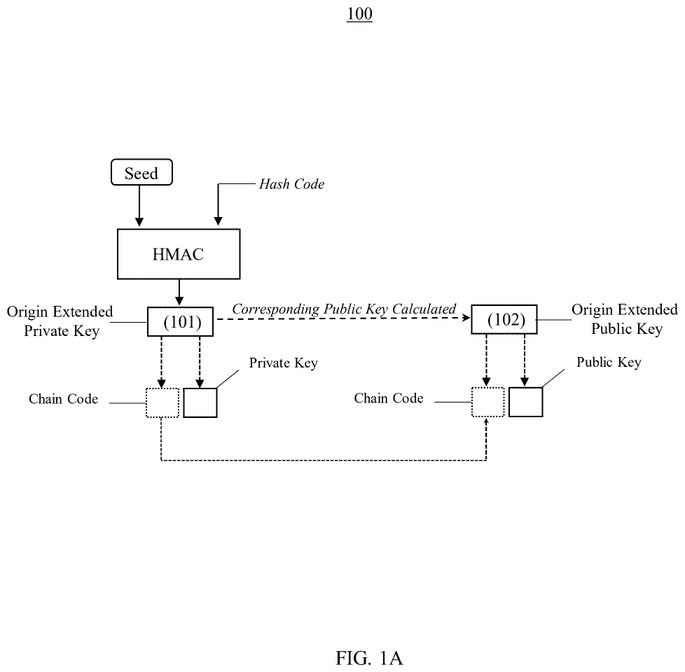

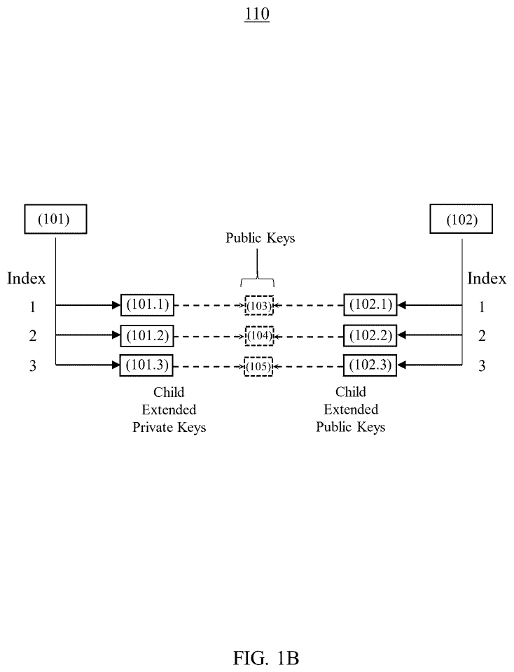

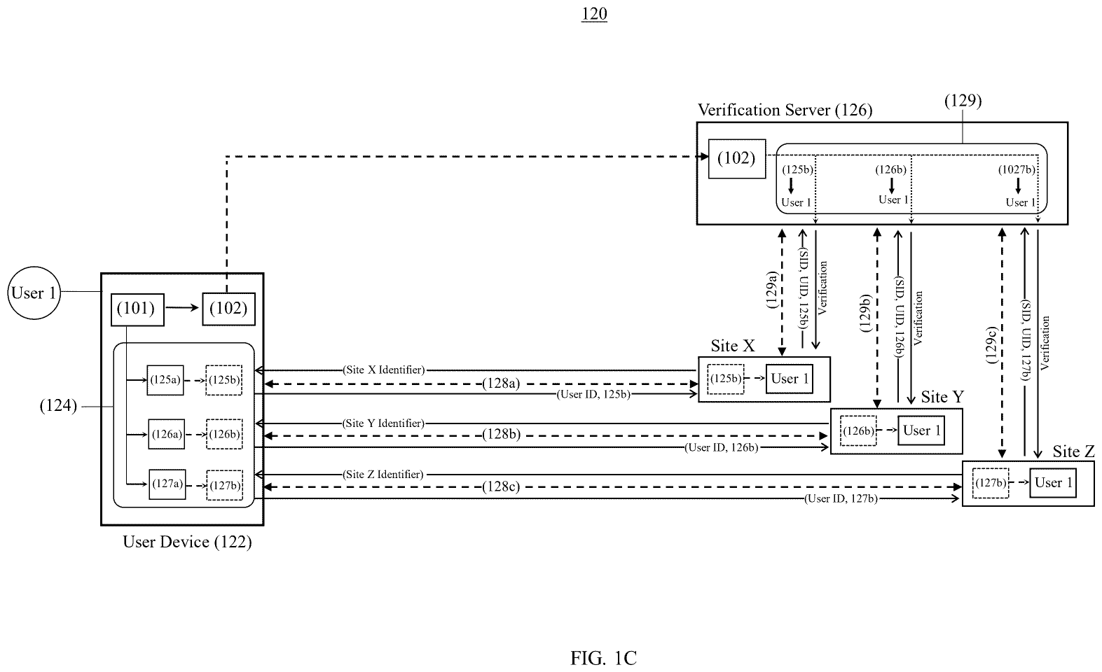

FIG. 1A illustrates an overview of an exemplary process associated with generation of extended origin private/public key as well as the hierarchical generation of child private/public key pairs, as further illustrated in FIG. 1B. With reference to example 100 in FIG. 1A, a randomly generated initial seed value may be used for computation of a origin extended private key 101, that may be stored on a user authenticator device (e.g., an NFC-enabled contactless card.) The computation may involve processing the seed data with a cryptographic hash function (e.g. Hashed Message Authentication Code (HMAC)) to generate the extended origin private key 101 as shown in FIG. 1A. As further illustrated in FIG. 1A, the resulting extended key may be divided into a portion representing the private key and a portion representing a chain code which may be used for hierarchical generation of the child private and public key pairs (e.g., by using enumeration index 1-3 as shown in FIG. 1B). Appending the chain code of the extended private key, to a corresponding public key, derived therefrom, creates a origin extended public key 102. Accordingly, a child public key derived from a child private key (e.g., with reference to enumeration index 1) may be validated without knowledge of the corresponding private key as it corresponds to the child public key derived from the extended public key 102, using the same enumeration index.

With reference to example 110 illustrated in FIG. 1B, a matching set of child public keys, associated with different iteration of the extended origin private key 101, may be independently computed from a corresponding extended origin public key 102. For example, child private keys 101.1, 101.2 and 101.3 computed based on index numbers 1, 2 and 3, respectively, correspond to child public keys 103, 104 and 105. The aforementioned child public keys are independently derivable from the corresponding extended origin public key 102 and correspond to the child public keys 102.1, 102.2 and 102.3 computed from the extended public origin key 102, using matching index numbers (e.g., 1-3). In some embodiments, the enumeration index may correspond to a unique identifier associated with a specific FIDO-reliant site. An example of a process wherein a unique site identifier is used for generating child key pairs representing site-specific FIDO security keys, is further illustrated in the exemplary implementation of verifiable FIDO security keys, shown in FIG. 1C.

In the exemplary FIDO registration process 120, illustrated in FIG. 1C, FIDO security key pairs are not generated randomly but rather correspond to hierarchically generated child key pairs derived from an extended FIDO private key 101. In the example 120, a site identifier, associated with a target FIDO-reliant site, may be used as an input index value to generate site-specific FIDO private/public key pairs. Accordingly, the process illustrated in FIG. 1C enables an issuing entity, associated with a FIDO authenticator device, to re-derive a matching public key for a specific site identifier, based on the extended public key. If a matching public key is computed, the FIDO public key registered for a specific user may then be validated and tied to a verifiable user identity, thus allowing FIDO identity verification to be ported to the issuing entity associated with one or more user accounts and/or authenticator devices. In this way, a site-specific FIDO public key, provided by a user during a FIDO registration process, can be securely tied to a user identity by verifying it against an extended origin public key maintained by the issuing entity. A site-specific public key, retrieved during a FIDO registration process, may then be used to verifiably authenticate the FIDO signature, generated by a site-specific FIDO private key, as well as the identity of a user and/or user device initiating the FIDO registration process.

Referring back to the exemplary FIDO registration process 120, the extended origin security key pairs (e.g., including an extended private and public keys) are stored on a user device 122 belonging to user 1. The extended origin security key pairs may be computed by the user device (e.g., in accordance to the process illustrated in FIG. 1A), or computed externally and stored on the user device 122. The user device may correspond to an authenticator device 122 implemented as an NFC-enabled contactless card, a mobile application running on a user mobile device and/or computing device, or any combination thereof. The authenticator device 122 may be running a process 124, for hierarchically deterministic generation of unique child private/public key pairs from the extended origin private key 101. A corresponding extended origin public key 102 may further be generated from the extended origin private key 101, and subsequently transmitted to a verification server 126, administered by an issuing entity associated with the user device 122 and/or one or more financial accounts associated with user 1.

During a FIDO registration process, a unique set of private/public child key pairs may then be generated for FIDO registration with each FIDO-reliant site. The example 120 illustrates three distinct FIDO-reliant sites referenced as site X, site Y and site Z. Network communication links 128a, 128b and 128c represent FIDO registration sessions, initiated by the user device 122, with each of the FIDO-reliant sites X, Y and Z, respectively. The FIDO registration process may be initiated by the child key pair generation process 124 executing on the user device 122. In response to receiving a FIDO registration request from the user device 122 (belonging to user 1), a site identifier may be transmitted back to the user device 122. Process 124, executing on the user device 122, may then use the received site identifier as an input index value (similar to the enumeration index numbers illustrated in FIG. 1B) to generate a unique site-specific child private FIDO key for a particular FIDO-reliant site (e.g., child private keys 125a, 126a, 127a corresponding to site identifiers for FIDO-reliant sites X, Y and Z.) A corresponding child public FIDO key is then computed from each of the child private FIDO keys (e.g., child public keys 125b, 126b, 127b derived from child private FIDO keys 125a, 126a, 127a). The child private key, for each FIDO-reliant site, is kept on the authenticator device (for digitally signing an issued FIDO challenge during a FIDO login process), while a corresponding child public key, along with a user identifier (e.g., a user name, email address, phone number associated with User 1), is transmitted to the FIDO-reliant site and/or service for verification of the said digital signature.

As further illustrated in FIG. 1C, each FIDO-reliant site may be in communication with a verification process 129, executing on the issuing and/or verification server 126. The communication may be facilitated across verification request sessions 129a, 129b, and 129c, associated with FIDO-reliant sites X, Y, and Z, respectively. During the FIDO registration process, each specific FIDO-reliant site may communicate with the remote verification process 129, in order to validate a FIDO public key received, in connection with a user identifier, during a FIDO registration phase with the particular FIDO-reliant site. With reference to FIG. 1C, the verification request session may include communication of a FIDO site identifier (SID), a user identifier (UID), and the site-specific public key received from the user device 122. The verification process 129 may involve derivation of a matching child public key using the data received across a specific verification request session, and the extended origin public key 102 stored on the verification server 126. A successful derivation of a child public key matching the FIDO public key provided in connection with the user identifier, may initiate the verification server to transmit a verification message back to the FIDO-reliant site. The verification response message provides the provenance determination and the identity binding required to successfully complete the FIDO registration process. This obviates a need for direct user-based authentication of the user identity during the FIDO registration phase.

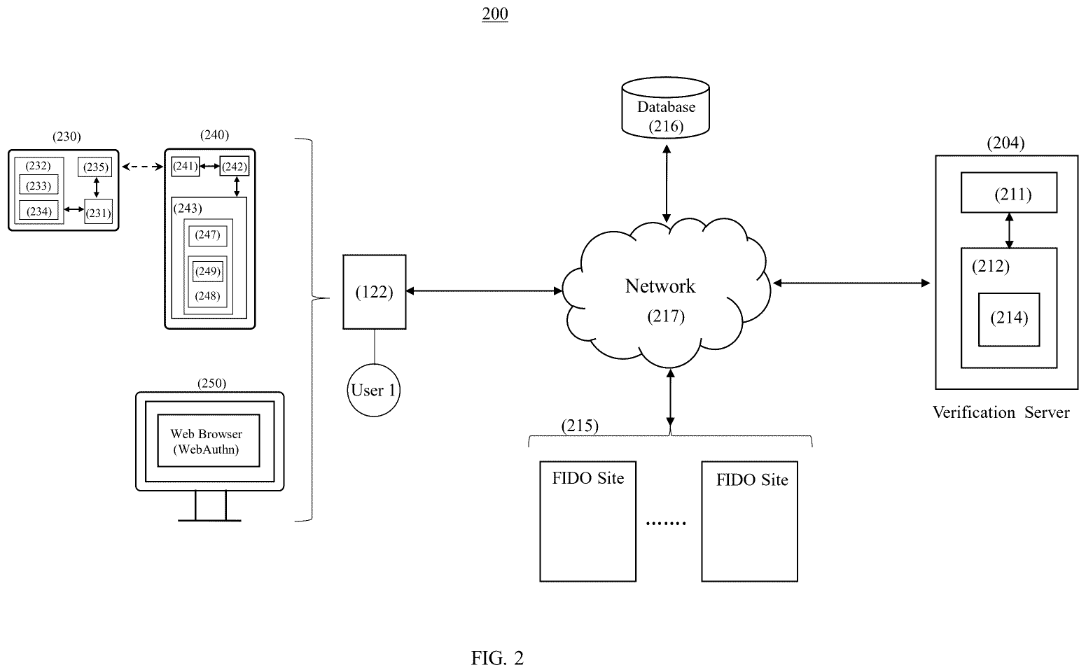

In some embodiments, the hierarchical generation of child keys based on the extended FIDO private key (e.g., process 124) may be implemented on a user device 122, and the user identity binding (e.g., verification process 129), based on the extended FIDO public key, may be running on a server associated with the issuing entity 126. In addition to a user device initiating the FIDO registration process with one or more FIDO-reliant servers, and a verification server associated with one or more user accounts, an exemplary system implementation for the process described with respect to FIG. 1C may further comprise a network and a data repository as represented by example 200, illustrated in FIG. 2. Although FIG. 2 illustrates single instances of components of system 200, system 200 may include any number of components.

As described above, the public key verification and user identity binding process may be executing on a verification server 204. The verification server 204 may be associated with the issuing entity of the user authenticator device. As shown in the exemplary system implementation 200, illustrated in FIG. 2, the verification server 204 may include one or more processors 211 (e.g., one or more microprocessors), coupled to memory 212, which may be, for example, random access memory (RAM), read-only memory (ROM), programmable read-only memory (PROM), erasable programmable read-only memory (EPROM), and/or electrically erasable programmable read-only memory (EEPROM). Memory 212 may include one or more applications, such as applications 214, to enable performance of the functions and processes described herein. According to the exemplary embodiment 200, the FIDO signature verification and user identity binding process (e.g., process 129) may be implemented as part of application 214 stored on the verification server 204. The verification server 204 may be in data communication with any number of components of system 200. For example, verification server 204 may be configured as a central system, server or platform to control and call various data at different times to execute a plurality of workflow actions. The verification server 204 may be configured to connect to one or mode FIDO-reliant servers 215 associated with various FIDO-protected accounts.

FIDO-reliant server(s) 215 may be in data communication with application 214 running the FIDO signature verification process. For example, the FIDO-reliant servers 215 may be in data communication with applications 214 via one or more networks 217. The FIDO-reliant servers 215 may transmit, to applications 214 executing on the verification server 204, one or more verification requests associated with the validation of registration data submitted by a user during a FIDO registration process. Registration data may comprise a FIDO public key and a user identifier. One or more user identifiers, such as a user name, user email address or a user phone number, may be stored on memory 212 of the verification server 204 and/or retrieved from a databases 216. Verification server 208 may receive one or more verification requests from FIDO-reliant server 215. Without limitation, the verification server 204 may be a network-enabled computer. As referred to herein, a network-enabled computer may include, but is not limited to a computer device, or communications device including, e.g., a server, a network appliance, a personal computer, a workstation, a thin client, a fat client, an Internet browser, a kiosk, a tablet, a terminal, or other device. The verification server 204 can be a dedicated server computer, such as bladed servers, or can be personal computers, laptop computers, notebook computers, network computers, or any processor-controlled device capable of supporting the system 200. While FIG. 2 illustrates a single account server 204, it is understood that other embodiments can use multiple servers or multiple computer systems as necessary or desired to support the users and can also use back-up or redundant servers to prevent network downtime in the event of a failure of a particular server.

The verification server 204 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The verification server 204 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the verification sever that is available and supported by the verification server, such as a touch-screen, keyboard, mouse, cursor-control device, touch-screen, microphone, digital camera, video recorder or camcorder. These devices may be used to enter information and interact with the software and other devices described herein.

System implementation 200 can include one or more databases 216. The one or more databases 216 can comprise a relational database, a non-relational database, or other database implementations, and any combination thereof, including a plurality of relational databases and non-relational databases. In some examples, the databases 216 can comprise a desktop database, a mobile database, or an in-memory database. Further, the one or more databases 216 can be hosted internally by any component of system 200, such as the verification server 204. The one or more databases 216 can also be hosted externally to any component of the system 200, by a cloud-based platform, or in any storage device that is in data communication with the verification server 204 and the FIDO-reliant servers 215. In some examples, the databases 216 can be in data communication with any number of components of system 200. For example, the verification server 204 can be configured to retrieve the data, requested by the FIDO-reliant servers 215, from the databases 216. Verification server 204 can be configured to transmit the received data from databases 216 to the FIDO-reliant servers 215 via network 217, the received data being responsive to the transmitted one or more verification requests (e.g., for public key validation and user identity binding) by one or more of the FIDO-reliant servers 215. One or more verification requests may be responsive to one or more FIDO registration requests initiated, for example, by the user device 122.

In some examples, network 217 may be one or more of a wireless network, a wired network or any combination of wireless network and wired network and may be configured to connect to any one of components of system 200. For example, the verification server 204 may be configured to connect to FIDO-reliant servers 215 via network 217. In some examples, network 217 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 217 may include, without limitation, telephone lines, fiber optics, IEEE Ethernet 902.3, a wide area network, a wireless personal area network, a LAN, or a global network such as the Internet. In addition, network 217 may support an Internet network, a wireless communication network, a cellular network, or the like, or any combination thereof. Network 217 may further include one network, or any number of the exemplary types of networks mentioned above, operating as a stand-alone network or in cooperation with each other. Network 217 may utilize one or more protocols of one or more network elements to which they are communicatively coupled. Network 217 may translate to or from other protocols to one or more protocols of network devices. Although network 217 is depicted as a single network, it should be appreciated that according to one or more examples, network 217 may comprise a plurality of interconnected networks, such as, for example, the Internet, a service provider's network, a cable television network, corporate networks, such as credit card association networks, and home networks.

Referring back to FIG. 2, the user device 122 (e.g., the device initiating the FIDO registration process) may transmit, along with a FIDO registration request, a user identifier associated with User 1 to a FIDO-reliant site 215 during the FIDO registration process. In response, a receiving FIDO-reliant site may transmit a site identifier back to the device from which the FIDO registration request was sent. Upon receiving the site identifier, the user device 122 may compute a site-specific FIDO security key pair and transmit the FIDO public key of the key pair to the FIDO-reliant site, over network 217. As described above, the generation site-specific FIDO security key pairs (e.g., a private and a public key) may be performed by process 124 running on the user device 122. The site-specific key pairs for each FIDO site identifier received, from the one or more FIDO-reliant sites 215, may be generated from an extend origin private key, using a hierarchically deterministic key generation protocol. In some embodiments, one or more operational aspects of process 124 may involve wireless interactions between a contactless card 230 and a mobile communication device 240 and/or or a computing device 250 (e.g., a laptop, tablet or a desktop computer.) In such embodiments, involving interaction with the contactless card 230, the contactless card 230 may store the extended origin private/public key pairs (e.g., extended private key 101 and a corresponding extended public key 102.) The extended origin key pair may be generated externally and stored onto an integrated memory of the contactless card 230, or it may be generated internally by the contactless card 230, and stored onto its integrated memory. As such, the contactless card may comprise an integrated processor 231 (e.g., for generating the extended security key pair and hierarchically computing various site-specific FIDO key pairs) and an integrated memory 232 (e.g., for storing the extended/child security keys). The integrated memory 232 may further store one or more applets 233 that may be communicatively coupled to one or more applications (e.g. application 247) running on a user communication device (e.g., mobile device 240). The integrated memory 232 may also store an application transaction counter 234 to keep track of a proper sequence of operations associated with an authentication transaction conducted using the contactless card 230. The contactless 230 may further comprise a Near Field Communication (NFC) interface 235 to facilitate an NFC communication with the user communication device 240 (e.g., with a reader component 241 of the mobile device 240).

In the above described embodiment, applet 233 may further be configured to transmit the extended origin public key 102 (generated/stored as NFC transmittable data) to an NFC reader, such as reader component 241 of the mobile device 240. For example, the data may be directly captured by the reader component 241 of the mobile device 240 by bringing the contactless card 230 within an NFC range of the mobile device 240 (e.g., by tapping the contactless card on a reader of a user mobile device) to initiate a direct read of the FIDO credentials, such as the extended origin public key and/or the site-specific child public keys, by the mobile device 240. The extended origin public key, retrieved from the contactless card may then be transmitted, across network 217, to the verification server 204, while the site-specific child public keys are transmitted, as part of the FIDO registration data (e.g., for a FIDO registration request initiated by the mobile device 240), to one or more FIDO-reliant site 215.

In some embodiments, the hierarchical generation of site-specific FIDO key pairs, (e.g., process 124) may be executing on the device initiating the FIDO registration process such as the mobile device 240. (e.g., running as part of application 247.) The site-specific FIDO public keys may then be generated on the user mobile device 240 and transmitted, via a web browser application 248 comprising a web API 249, such as Web Authentication (WebAuthn), to a FIDO-reliant site, as part of FIDO registration data.

The mobile device 240, may be configured for wireless communication with the contactless card 230 via a short-range wireless connection (e.g., NFC), and network communication with the verification server 204 and/or the FIDO-reliant sites 215. The mobile device 240 may correspond to a network-enabled computer which can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The user mobile device 240 may include a reader component 241 for communicating with the NFC interface 235 of the contactless card 230, a processor 242, and a memory 243 storing one or more applications (e.g., application 247 and/or application 248). The processor 242 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

In some embodiments, the authenticator device may correspond to a user contactless card 230 storing extended origin security key pairs on its internal memory 232 and further comprising a processor 231 configured to generate site-specific child FIDO key pairs for registering with various FIDO-reliant services. The contactless card 230 may have a near-field communication (NFC) interface 235, readable by a user communication device 240. The communication device 240 may then server as an intermediary device for retrieving FIDO credentials, such as site-specific FIDO public key and transmitting it to a FIDO-reliant service across a network. The intermediary device may further receive an incoming FIDO challenge request and transmit the challenge request, via NFC, to the contactless card 230 to be signed with a corresponding site-specific FIDO private key, thus generating a site-specific digital signature. The site-specific digital signature may then be transmitted back to the challenge-initiating FIDO site/service 215, via the intermediary mobile device 240.

In some embodiments the initial FIDO access initiating device (e.g., for conducting a FIDO registration) may correspond to a user computing device 250 executing the hierarchical site-specific child key pair generation process (e.g., process 124) from an internally stored extended origin private key. The computing device 250 may further be running a web API such as Web Authentication (WebAuthn) for communication with the FIDO-reliant sites 215. The extended origin public key, computed from the extended origin private key, may be communicated by the computing device 250, across the network 217, to the verification server 204.

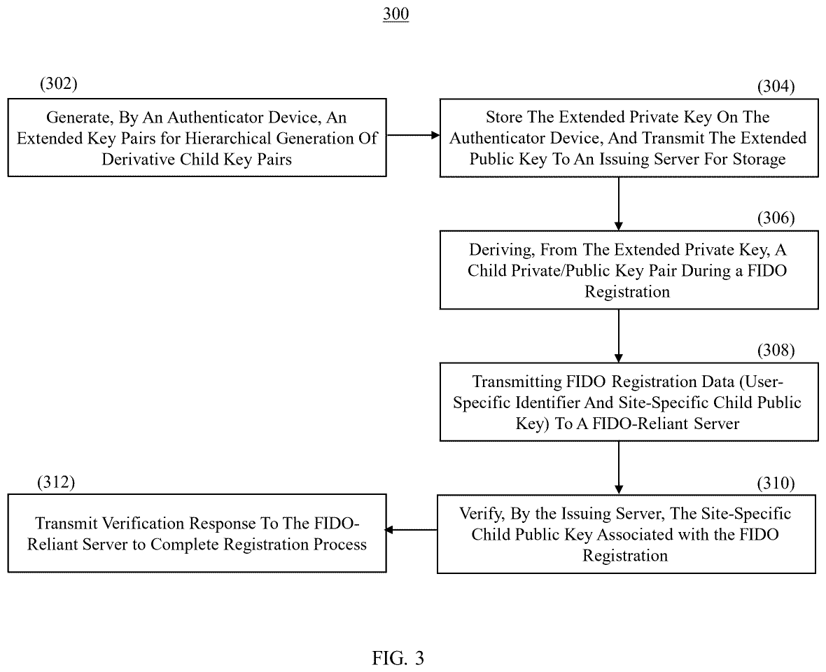

FIG. 3 illustrates an exemplary process flow for implementation of verifiable FIDO security keys for streamlining a FIDO registration process. The first step of the process (e.g., step 302) involves the generation of an extended origin/master key pair, including an extended origin private key from which an extended origin public key may be derived. The extended origin private key may be used in further derivation of child key pairs using hierarchically deterministic generation protocol. As described above the generation of the extended origin/master key pair may be carried out by the user authenticator device, or externally provided and stored onto the user authenticator device. At step 304, the extended origin private key is stored on the user authenticator device, and the extended origin public key is transmitted to a verification server maintained by an issuer of the user authenticator device. Alternatively, the verification server may be provisioned with the extended origin public key during the personalization of the user authenticator device, while the corresponding extended origin private key is provisioned/stored onto the user authenticator device that initiates the FIDO registration process (e.g., mobile device 240 running application 247) or on an external user device with wireless communication capability to the user authenticator device (e.g., contactless card 230 with an NFC interface 241.)

In response to receiving a site identifier from the target FIDO-reliant server, a pair of site-specific FIDO security keys, including a private and public child key, is hierarchically derived from the extended origin private key (e.g., stored on the authenticator device) using the site identifier as an index input value, as described in step 306. The user authenticator device maintains control of the private child key for generating a digital signature, that may be verified by the corresponding public child key. During the FIDO registration process, registration data may be transmitted to a FIDO-reliant server by a user authenticator device as shown in step 308. The FIDO registration data may comprise a user-specific identifier and a site-specific FIDO public key (e.g. public child key derived from the corresponding private child key, for a specific FIDO-reliant site.)

The FIDO-reliant server may then send a verification request to a issuing server associated with the user authenticator device. The issuing server performs a verification of the received FIDO public key by computing a matching child public key from the extended public key stored in association with the user-specific identifier. This verification process is represented in step 310. The verification process may involve a re-derivation of the site-specific child public key from the extended FIDO public key associated with a user account (e.g., as identified by the user identifier). If the re-derived key matches the FIDO public key received from the FIDO-reliant server, a validation/verification response is sent, by the issuing entity (e.g., verification server 204), back to the FIDO-reliant server, as shown in step 312. At this point the user and/or the user authenticator device may be securely registered by the FIDO-reliant server/site in connection with the provided user identifier.

As described above, the authenticator device may correspond to a user contactless card, whereby the site-specific child FIDO key pairs are generated internally on the contactless card using an extended origin/master private key. In an event that the contactless card is lost, stolen or rendered non-functional at some point, a new contactless card may be issued (e.g., a replacement card) to replace a previous one. The new contactless card, however, may be provisioned with a distinct extended private key diversified based on data uniquely associated with the new/re-issued contactless card. Alternatively, the extended private key stored on the old/replaced card may be re-provisioned on the new/replacement card, while hierarchical derivation of child key pairs, on the replacement card, may be diversified with data uniquely associated with the replacement card. In either case, newly derived site-specific private/public key pairs may include a card-specific diversification component. In some embodiments, the card-specific diversification may involve including an issuance counter value to be used as input index value in the generation of the child site-specific key pair. In some embodiments, the diversification process may involve assignment of unique extended origin private/public key pairs to the replacement contactless card. In any of such cases, the hierarchically derived site-specific child key pairs computed on the replacement contactless card may be different that the previously registered FIDO credentials maintained by one or more FIDO-reliant sites in association with the user identifier (e.g., FIDO registrations previously performed by the replaced card). Accordingly, the replacement card may need to be re-registered with all the FIDO sites holding registration data associated with the replaced contactless card.

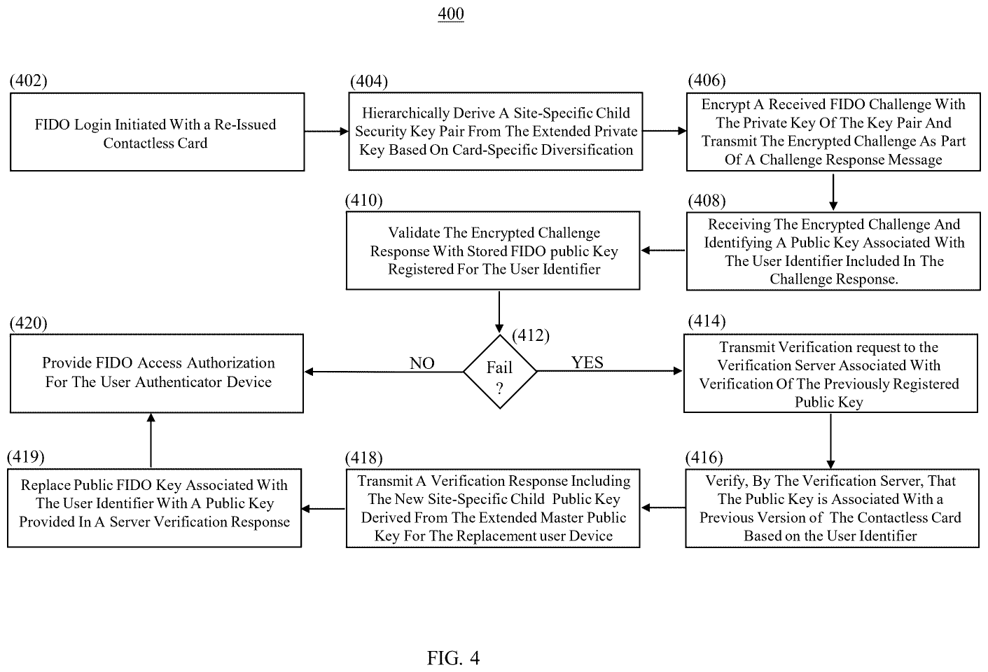

FIG. 4 illustrates an exemplary implementation of the FIDO login process facilitated by the use of the extended origin public key, to port FIDO signature verification and user identity binding to a trusted external entity (e.g., a verification server associated with the user authenticator device). The aforementioned implementation, illustrated by exemplary process flow 400 in FIG. 4, may be leveraged to obviate a need for re-registration of a re-issued authenticator device (e.g., a replacement device) provided to replace a de-activated user authenticator device which may have been previously registered with one or more FIDO services (e.g., a replaced authenticator device corresponding to a lost, stolen and/or non-functioning device).

As shown at step 402, a user may directly initiate a FIDO login/access request using, for example, a re-issued contactless card, with a FIDO account previously registered against a replaced contactless card. The FIDO login request may include a user identifier, such as an email or a phone number previously used for FIDO registration of the replaced device. A FIDO challenge request issued by the FIDO-reliant server (e.g., hosting the FIDO-protected account) is then signed using a new hierarchically derived site-specific child private key, and transmitted to the FIDO-reliant server for validation, as shown in steps 404 and 406.

Upon receiving the encrypted FIDO challenge response, a registered FIDO public key previously associated with the user identifier, may be used to decrypt the challenge response, as shown in steps 408 and 410. At step 412, a result of the decryption action is evaluated. If the decryption action fails, the process moves to step 414, wherein a verification request message comprising the previously registered site-specific public key and the corresponding user identifier, are sent to the verification server. The verification server may correspond to the server that was involved in the validation of the FIDO public key during the initial registration process with the replaced user device (e.g., previously registered authenticator device).

The verification server may then verify that the received site-specific public key corresponds to a public key associated with a previous version of the authenticator device. If the verification is successful, a verification message along with the new site-specific FIDO public key derived from the extended public key associated with the replacement authenticator device (e.g., re-issued contactless card) is then transmitted back to the FIDO-reliant server, as shown in steps 416 and 418.

Upon receiving the verification response, and the accompanying data, from the verification server, the FIDO-reliant server may decrypt the encrypted challenge response with the new site-specific FIDO public key provided by the verification server. Upon successful validation of the challenge response, the previously registered public key associated with the user identifier may be replaced with the new site-specific FIDO public key, as shown in step 419. In response to a successful decryption and validation of the FIDO challenge response, FIDO access may be provided to the re-issued/replacement user authenticator device, as shown at step 420, without requiring a re-registration of the replacement device with the FIDO-reliant server.

As described above a contactless card may be used for storage of an extended origin/master security keys and derivation of child security key pairs representing unique site-specific FIDO key pairs for conducting secure FIDO transactions with various FIDO-reliant services. In the implementation examples described above, the extended origin public key, computed from the extended origin private key, is maintained by a verification server associated with the issuing entity of the user authenticator device and not shared with various FIDO-reliant sites/services (i.e., to prevent tracking of various user FIDO transactions conducted with various site-specific child public keys). This scheme enables the user identity verification and provenance determination, during a FIDO registration process, to be performed by a trusted verification server storing the extended origin public key (e.g., without reliance upon user-provided authentication credentials) while enabling transparency of user FIDO transactions with various FIDO-reliant services as the extended origin public key is only shared with the trusted verification entity associated with the user account and/or user authenticator device(s).

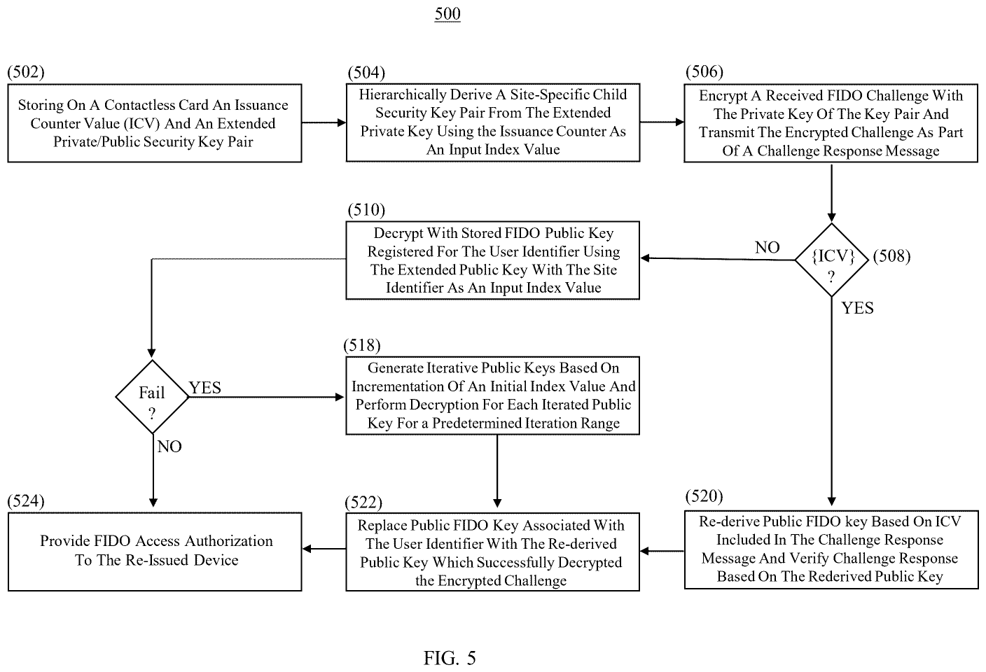

However, in cases where privacy is not a main concern, a different embodiment of the described external verification methodology may involve transmission of the extended public origin key, as part of the FIDO registration data, to each FIDO-reliant service. In the aforementioned embodiment, the FIDO registration data, transmitted in response to receipt of a site identifier during an initial registration process with a FIDO service, may comprise the extended public origin key, derived from the extended private origin key stored on the user authenticator device. Accordingly, the site-specific public child for verifying a FIDO signature may be generated independently by a receiving FIDO service during a FIDO login attempt. The described process as illustrated by the exemplary process flow in FIG. 5, would obviate a need for the user to re-register a new re-issued device such as a re-issued contactless with the same online services registered against a previous authenticator device (e.g., corresponding to a lost or expired device), and can be implemented without involvement of the issuing entity.

With reference to FIG. 5, the process flow 500 may involve an issuance counter value (ICV), stored on a user authenticator device (e.g., contactless card) for tracking a number of times a FIDO-enabled contactless transaction card has been re-issued for a particular user identifier, as shown by step 502. The ICV data, stored onto a contactless card (e.g., during the personalization phase) may represent an enumeration index for deterministically diversifying a FIDO digital signature (e.g., a child private key) and a FIDO signature verification key (e.g., a child public key corresponding to the child private key) based on the ICV value (e.g., version number of a user authenticator device), as represented by steps 504 and 506 of the exemplary process flow 500.

The ICV data may be communicated, as part of a FIDO login/access request message, to a FIDO-reliant site storing an extended FIDO public key in association with a user identifier (e.g., provided during the FIDO registration phase). At step 508, a receiving FIDO-reliant server may determine if an ICV value is included in a FIDO access/login request transmitted from a user device. Accordingly, during a FIDO login process using a re-issued contactless card (e.g., a second contactless card associated with the same user identifier), if matching user identifier is detected along with ICV data in the FIDO access request, the receiving FIDO-reliant server may re-derive the child public key using the ICV value transmitted during a FIDO login request, as shown in step 520. The new FIDO public key is then registered for the user identifier, replacing an existing FIDO public key, as shown in step 522.

Alternatively, if step 508 determines that the ICV data, that may have been used in generation of the site-specific child private key, is not transmitted as part of the FIDO communication from the FIDO access-initiating user device, the process may move to step 510 wherein an initial attempt is made to decrypt the signed FIDO challenge with a registered FIDO public key associated with the user identifier, as previously obtained during the initial registration process. In this scenario no indication of a re-issued extended security key pair and resulting modification to the site-specific FIDO signature (e.g., the corresponding child private key) is communicated to the FIDO-reliant server. Accordingly, the first attempt at decrypting the digital signature (e.g., encrypted challenge response) may fail due to the discrepancy between the FIDO private key and a corresponding FIDO public key associated with the registered user FIDO account.

Upon detecting this failure, the process moves to step 518 wherein an iterative operation is carried out to find a matching public key within a predetermined number of tries. If a matching public key that successfully decrypts and validates the challenge response, is found within the predetermined number of iterations, the process moves to step 522 wherein the registered FIDO public key, associated with the user identifier, is replaced with the re-derived FIDO public key. Once an encrypted challenge response is successfully decrypted and validated by the receiving FIDO service, FIDO login request from the re-issued authenticator device is authorized as shown in step 524.

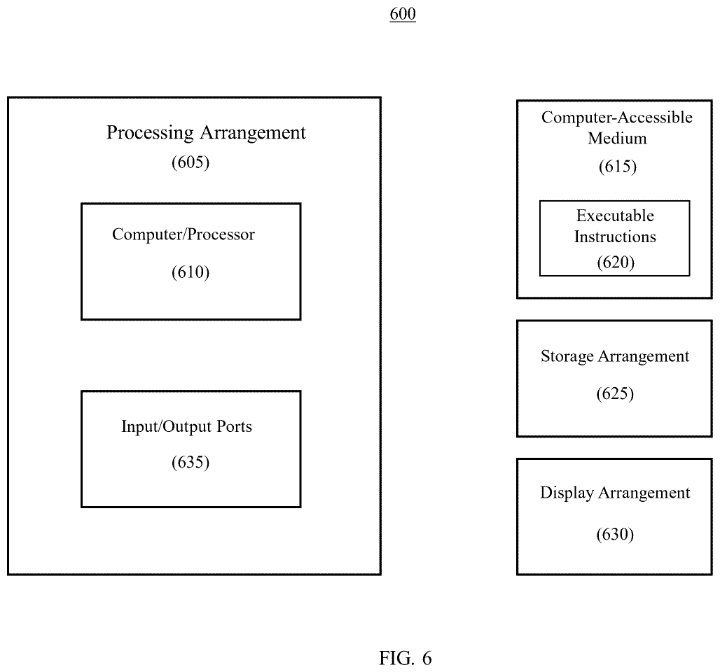

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 605 may be configured for hierarchical generation FIDO key pairs and user identity binding with registered FIDO public keys). Such processing and/or computing arrangement 605 can be, for example entirely or a part of, or include, but not limited to, a computer and/or processor 610 that can include, for example one or more microprocessors, and use instructions stored on a computer-accessible medium (e.g., RAM, ROM, hard drive, or other storage device).

As shown in FIG. 6, for example a computer-accessible medium 615 (e.g., as described herein above, a storage device such as a hard disk, floppy disk, memory stick, CD-ROM, RAM, ROM, etc., or a collection thereof) can be provided (e.g., in communication with the processing arrangement 605). The computer-accessible medium 615 can contain executable instructions 620 thereon. In addition or alternatively, a storage arrangement 625 can be provided separately from the computer-accessible medium 615, which can provide the instructions to the processing arrangement 605 so as to configure the processing arrangement to execute the exemplary procedures, processes, and methods, as described herein above, for example.

Further, the exemplary processing arrangement 605 can be provided with or include an input and/or output ports 635, which can include, for example a wired network, a wireless network, the internet, an intranet, a data collection probe, a sensor, etc. As shown in FIG. 6, the exemplary processing arrangement 605 can be in communication with an exemplary display arrangement 630, which, according to certain exemplary embodiments of the present disclosure, can be a touch-screen configured for inputting information to the processing arrangement in addition to outputting information from the processing arrangement, for example. Further, the exemplary display arrangement 630 and/or a storage arrangement 625 can be used to display and/or store data in a user-accessible format and/or user-readable format.

Systems and methods described herein can provide secure and streamlined FIDO authentications. Once a valid FIDO verification response from an issuing server, storing a valid extended public key, has been established, the authenticated FIDO access can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a method for generation of a verifiable fast identification online (FIDO) security key, the method including: generating an extended public key from an extended private key, the extended public key being stored with an account issuing entity; deriving, from the extended private key, a plurality of child key pairs, including a plurality of child private keys and a plurality of corresponding child public keys, wherein the extended private key is stored on an authenticator device associated with a user, the authenticator device being provided by the account issuing entity; initiating a FIDO registration of the authenticator device with a FIDO-reliant site using a user-specific identifier and a site-specific child public key derived for the FIDO-reliant party; sending, by the FIDO-reliant party, the user-specific identifier and the site-specific child public key to the issuing entity; verifying, by the account issuing party, that the site-specific child public key is associated with the user-specific identifier using the extended public key to derive a matching key; and completing the FIDO registration upon receiving a verification message from the account issuing entity.

In some aspects, the techniques described herein relate to a method, wherein the account issuing party corresponds to a financial institution associated with a user financial account.

In some aspects, the techniques described herein relate to a method, wherein the user-specific identifier corresponds to one of a user name and an email address associated with the user.

In some aspects, the techniques described herein relate to a method, wherein a FIDO challenge request from the FIDO-reliant party is signed by a child private key corresponding to the child public key registered with the FIDO-reliant site.

In some aspects, the techniques described herein relate to a method, wherein the FIDO challenge request is transmitted in response to a FIDO authentication request initiated from the authenticator device storing the extended private key.

In some aspects, the techniques described herein relate to a method, wherein the authenticator device corresponds to a contactless card.

In some aspects, the techniques described herein relate to a method, wherein the contactless card communicates with the FIDO-reliant party, via an intermediary communication device.

In some aspects, the techniques described herein relate to a method, wherein the authenticator device corresponds to a computing device storing the extended private key,

In some aspects, the techniques described herein relate to a system for implementing a pre-registration of FIDO security keys, the system including an authenticator device including a processor; and a memory, the memory containing a user-specific identifier, an extended private FIDO key generated using a hierarchically deterministic key generation algorithm, wherein the processor is configured to: generate a child FIDO key pair including a child private key and a child public key; transmit the child public key along with the user-specific identifier to a FIDO-reliant server during a FIDO registration process associated with the authenticator device; a server, including a processor; and a memory, containing the user-specific identifier and an extended public FIDO key generated from the extended private FIDO key, the processor being configured to: receive the child public key along with the user-specific identifier from the FIDO reliant server during the FIDO registration process of the authenticator device, verify that the child public key is associated with the user-specific identifier using the extended public key; and transmit a verification message to the FIDO-reliant server, the verification being operative to complete a registration of the authenticator device associated with the child public key and the user-specific identifier.

In some aspects, the techniques described herein relate to a system, Wherein the server is associated with an issuer of the authenticator device for a user identified by the user-specific identifier.

In some aspects, the techniques described herein relate to a system, wherein the issuer of the authenticator device corresponds to the account issuing party.

In some aspects, the techniques described herein relate to a system, wherein the child public key corresponds to a site-specific FIDO public key uniquely associated with the FIDO-reliant server.

In some aspects, the techniques described herein relate to a system, wherein the unique association is generated by using a site-specific identifier for generating the child FIDO key pair.

In some aspects, the techniques described herein relate to a system, wherein the verification includes deriving a child public key from the origin public key and confirming a match between the generated child public key and the received child public key.

In some aspects, the techniques described herein relate to a system, Wherein the deriving of the child pubic key includes using a site-specific ID received from the FIDO-reliant party along with the extended public key to derive the child public key for matching against a registered child public key.

In some aspects, the techniques described herein relate to a non-transitory computer-accessible medium including instructions for execution by a computer hardware arrangement, wherein, upon execution of the instructions the computer hardware arrangement performs procedures including: generating an extended public key from an extended private key, the extended public key being stored with an account issuing entity; deriving, from the extended private key, one of more child key pairs including a child private key and a corresponding child public key, wherein the origin private key is stored on an authenticator device associated with a user, the authenticator device being provided by the account issuing entity; initiating a FIDO registration of the authenticator device with a FIDO-reliant party using a user-specific identifier and a site-specific child public key derived for the FIDO-reliant party; sending, by the FIDO-reliant party, the user-specific identifier and the site-specific child public key to the issuing entity; verifying, by the account issuing party, that the site-specific child public key is associated with the user-specific identifier using the extended public key to derive a matching key; and completing the FIDO registration upon receiving a verification message from the account issuing entity.

In some aspects, the techniques described herein relate to a non-transitory computer-accessible medium, wherein the account issuing party corresponds to a financial institution associated with a user financial account.

In some aspects, the techniques described herein relate to a non-transitory computer-accessible medium, wherein the user-specific identifier corresponds to one of a user name and an email address associated with the user.

In some aspects, the techniques described herein relate to a non-transitory computer-accessible medium, wherein a FIDO challenge request from the FIDO-reliant party is signed by a child private key corresponding to the child public key registered with the reliant site.

In some aspects, the techniques described herein relate to a non-transitory computer-accessible medium, wherein the FIDO challenge request is transmitted in response to a FIDO authentication request initiated from the authenticator device storing the extended private key.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for generation of a verifiable fast identification online (FIDO) security key, the method comprising:
generating an extended public key from an extended private key, the extended public key being stored with an account issuing entity;
deriving, from the extended private key, a plurality of child key pairs, including a plurality of child private keys and a plurality of corresponding child public keys, wherein the extended private key is stored on an authenticator device associated with a user, the authenticator device being provided by the account issuing entity;
initiating a FIDO registration of the authenticator device with a FIDO-reliant site using a user-specific identifier and a site-specific child public key derived for a FIDO-reliant party;
sending, by the FIDO-reliant party, the user-specific identifier and the site-specific child public key to the issuing entity;
verifying, by the account issuing party, that the site-specific child public key is associated with the user-specific identifier using the extended public key to derive a matching key; and
completing the FIDO registration upon receiving a verification message from the account issuing entity.

2. The method of claim 1, wherein the account issuing party corresponds to a financial institution associated with a user financial account.

3. The method of claim 1, wherein the user-specific identifier corresponds to one of a user name and an email address associated with the user.

4. The method of claim 1, wherein a FIDO challenge request from the FIDO-reliant party is signed by a child private key corresponding to the child public key registered with the FIDO-reliant site.

5. The method of claim 4, wherein the FIDO challenge request is transmitted in response to a FIDO authentication request initiated from the authenticator device storing the extended private key.

6. The method of claim 1, wherein the authenticator device corresponds to a contactless card.

7. The method of claim 6, wherein the contactless card communicates with the FIDO-reliant party, via an intermediary communication device.

8. The method of claim 1, wherein the authenticator device corresponds to a computing device storing the extended private key.

9. A system for implementing a pre-registration of FIDO security keys, the system comprising
an authenticator device comprising a processor; and
a memory, the memory containing a user-specific identifier, an extended private FIDO key generated using a hierarchically deterministic key generation algorithm, wherein the processor is configured to:
generate a child FIDO key pair including a child private key and a child public key;
transmit the child public key along with the user-specific identifier to a FIDO-reliant server during a FIDO registration process associated with the authenticator device;
a server, comprising a processor and a memory, the memory containing the user-specific identifier and an extended public FIDO key generated from the extended private FIDO key, wherein the processor being configured to:
receive the child public key along with the user-specific identifier from the FIDO reliant server during the FIDO registration process of the authenticator device,
verify that the child public key is associated with the user-specific identifier using the extended public FIDO key; and
transmit a verification message to the FIDO-reliant server, the verification being operative to complete a registration of the authenticator device associated with the child public key and the user-specific identifier.

10. The system of claim 9, Wherein the server is associated with an issuer of the authenticator device for a user identified by the user-specific identifier.

11. The system of claim 10, wherein the issuer of the authenticator device corresponds to an account issuing party.

12. The system of claim 9, wherein the child public key corresponds to a site-specific FIDO public key uniquely associated with the FIDO-reliant server.

13. The system of claim 12, wherein the unique association is generated by using a site-specific identifier for generating the child FIDO key pair.

14. The system of claim 9, wherein the verification comprises deriving a child public key from an origin public key and confirming a match between the generated child public key and the received child public key.

15. The system of claim 14, Wherein deriving the child public key comprises using a site-specific ID received from the FIDO-reliant server along with the extended public key to derive the child public key for matching against a registered child public key.

16. A non-transitory computer-accessible medium comprising instructions for execution by a computer hardware arrangement, wherein, upon execution of the instructions the computer hardware arrangement performs procedures comprising:
generating an extended public key from an extended private key, the extended public key being stored with an account issuing entity;
deriving, from the extended private key, one of more child key pairs including a child private key and a corresponding child public key, wherein the extended private key is stored on an authenticator device associated with a user, the authenticator device being provided by the account issuing entity;
initiating a FIDO registration of the authenticator device with a FIDO-reliant party using a user-specific identifier and a site-specific child public key derived for the FIDO-reliant party;
sending, by the FIDO-reliant party, the user-specific identifier and the site-specific child public key to the issuing entity;
verifying, by the account issuing party, that the site-specific child public key is associated with the user-specific identifier using the extended public key to derive a matching key; and
completing the FIDO registration upon receiving a verification message from the account issuing entity.

17. The non-transitory computer-accessible medium of claim 16, wherein the account issuing party corresponds to a financial institution associated with a user financial account.

18. The non-transitory computer-accessible medium of claim 16, wherein the user-specific identifier corresponds to one of a user name and an email address associated with the user.

19. The non-transitory computer-accessible medium of claim 16, wherein a FIDO challenge request from the FIDO-reliant party is signed by a child private key corresponding to the child public key registered with a FIDO-reliant site.

20. The non-transitory computer-accessible medium of claim 19, wherein the FIDO challenge request is transmitted in response to a FIDO authentication request initiated from the authenticator device storing the extended private key.
